(19) United States
(12) Patent Application Publication
(10) Pub. No.: US 2025/0314360 A1
(43) Pub. Date: Oct. 9, 2025

(54) Linear Lighting and Retaining System

(71) Applicant: ABC Marketing, Inc., Elkhart, IN (US)

(72) Inventors: Benjamin Miller, Bristol, IN (US); David Troup, Goshen, IN (US)

(73) Assignee: ABC Marketing, Inc., Elkhart, IN (US)

(21) Appl. No.: 19/097,392

(22) Filed: Apr. 1, 2025

Related U.S. Application Data
(60) Provisional application No. 63/631,597, filed on Apr. 9, 2024.

(51) Int. Cl. F21S 4/28; F21V 17/16; F21V 19/00; F21V 21/02; F21V 33/00

(52) U.S. Cl. CPC F21S 4/28; F21V 17/164; F21V 19/004; F21V 21/02; F21V 33/006

(57) ABSTRACT

A lighting system uses an existing track receiver for holding standard panel trim to hold an elongate linear light. The elongate linear light provides illumination and conceals the gap between panels. The light includes a snap track with arcuate portions that contact the panels. Between the arcuate portions is a trough portion that receives and retains an elongate luminaire strip. The trough portion has a narrow opening formed from the opposite ends of the arcuate portions which is complementary to side profile surfaces on the luminaire. The luminaire is retained only by the narrow opening engaging with the side profile surfaces. A snap-in cover conceals the terminal end of the snap track.

### CROSS REFERENCE TO RELATED APPLICATIONS

This application claims the benefit of Provisional Application Ser. No. 63/631,597, filed Apr. 9, 2024, the disclosure of which is incorporated by reference.

### BACKGROUND OF THE INVENTION

The present disclosure relates to interior illumination for enclosed living spaces, such as recreational vehicles, campers, trailers (RV). Currently, RV interior spaces use discrete lights placed over areas of interest or focus, such as seating areas, kitchen countertops, and hallways. The use of discrete lights requires specific wiring and holes drilled through the interior ceiling panels to mount the lights. An improved device is needed.

### SUMMARY OF THE INVENTION

The present disclosure describes a linear lighting system that affixes to an existing channel that is intended for a trim piece. By expanding and integrating lighting into a similar trim piece, diffused and task lighting is available without the need to drill holes in the ceiling panel and covers the unsightly joint between ceiling panels.

The lighting system conceals a gap between a first panel and a second panel and includes a track receiver, a snap track, and an elongate luminaire strip. The track receiver has a flange portion and a barb receiving portion that extends perpendicularly from the flange portion. The barb receiving portion has a pair of upstanding parallel walls, and each of the upstanding walls have protrusions that cooperate to form a barb-receiving channel. The snap track has a trough portion, a first resilient arcuate portion extends from a left side of the trough portion, and a second resilient arcuate portion that extends from a right side of the trough portion. The trough portion has a mouth that defines an opening to a valley and is narrower than the valley. The snap track has a barb that extends in a direction opposite of the mouth and the barb is receivable by the barb-receiving channel. The elongate luminaire strip has a first side profile surface, an oppositely located second profile surface, a diffuser surface that extends between the profile surfaces, and a back surface located opposite the diffuser surface. Each of the side profile surfaces have a chamfer surface that extends outwardly at an oblique angle from the back surface to an inner widest point. A groove on each side profile surface extends from the inner widest point and an outer widest point. The groove also has a convex surface that extends from the inner widest point to a groove wall. The groove wall extends to an outer chamfer surface and the outer chamfer surface extends to the outer widest point. The back surface extends between the chamfer surfaces of the first and second side profile surfaces. The elongate luminaire strip is releasably retained in the trough portion without adhesive when the grooves are located in the mouth and the inner widest points of the profile surfaces are located in the valley. As installed, the diffuser surface is proud of the first and second resilient arcuate portions. When the snap track is retained by the track receiver, the first arcuate portion is in biased contact with the first panel and the second arcuate portion is in biased contact with the second panel.

### BRIEF DESCRIPTION OF THE DRAWINGS

FIG. 1 is a front isometric view of a lighting system as installed;

FIG. 2 is an end view of the lighting system in FIG. 1;

FIG. 3 is an exploded isometric view of the system in FIG. 1;

FIG. 4A is an exploded section view 4A-4A of the system in FIG. 1;

FIG. 4B is an exploded section view 4B-4B of the system in FIG. 1;

FIG. 5 is an end view of an alternate luminaire strip;

FIG. 6 is an end view of an alternate luminaire strip as installed;

FIG. 7 is a bottom isometric view of the cap in FIG. 1; and

FIG. 8 is a rear isometric section view 8-8 of the system in FIG. 1.

### DESCRIPTION OF THE PREFERRED EMBODIMENT

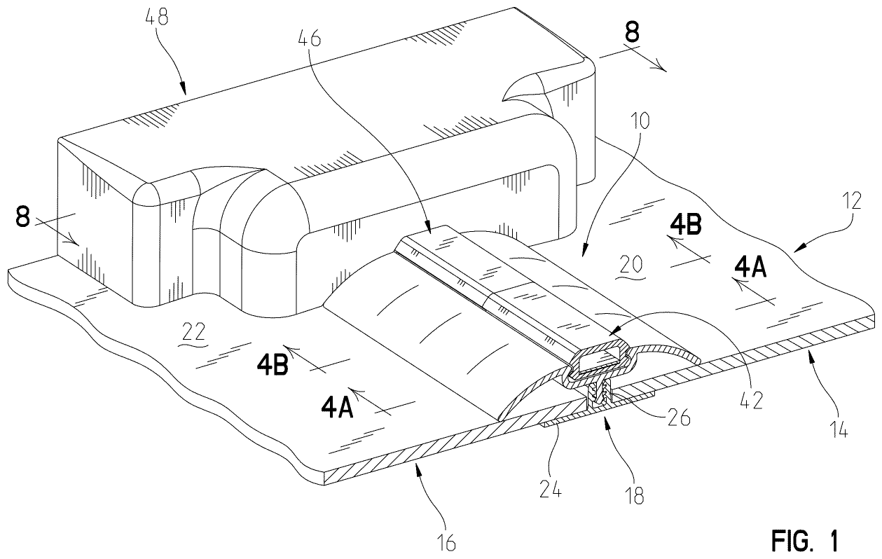

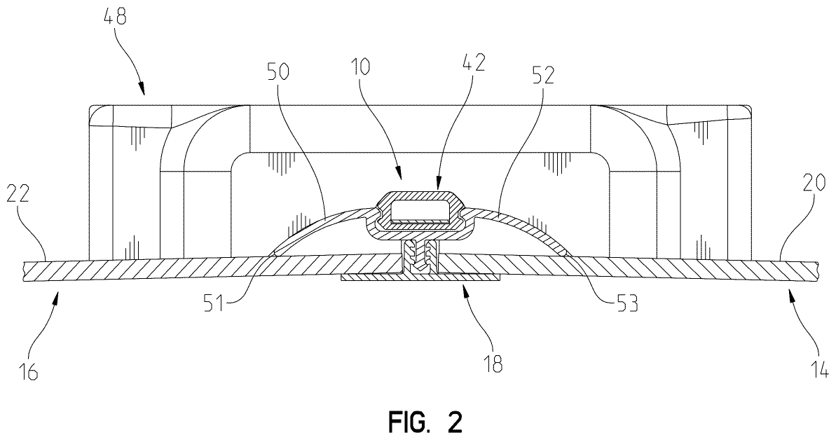

As shown in FIGS. 1-4, a linear lighting system 10 is an elongate structure that attaches to an existing surface 12 to conceal the junction between two panels 14, 16. The panels 14,16 are generally flat structures with a relatively smooth or decorative outer surface 20, 22. For the purposes of this disclosure, generally flat includes planar structures but is also defined to include curves, gentle bends, and/or surface texturing in one or more directions. For example, in a ceiling application, the panels 14, 16 would conform to a structure that is curved in one direction. The panels 14, 16 meet each other and abut a track receiver 18 that is held between them, as shown in FIGS. 1 and 2. The track receiver 18 has a flange portion 24 and a barb receiving portion 26 that forms a channel to receive a barb. Staples, screws, or other fasteners are driven through the panels 14, 16 and flange portion 24 to secure them to the vehicle or living space. The flange portion 24 rests against the inner surfaces of the panels 14, 16 and the barb receiving portion 26 is located between edges of the panels 14, 16. The barb receiving portion 26 is formed from two upstanding walls with inwardly facing barbs. The panels 14, 16 and track receiver 18 are well-known in the art. As described herein, the panels 14, 16 are commonly used for a ceiling but could be affixed to or part of a wall.

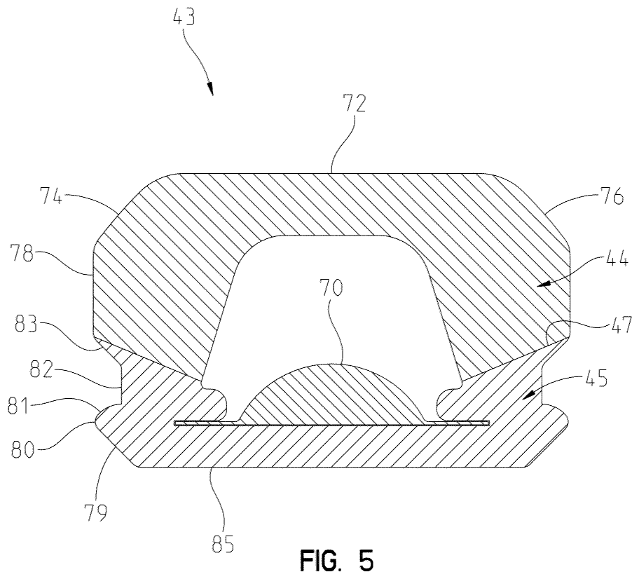

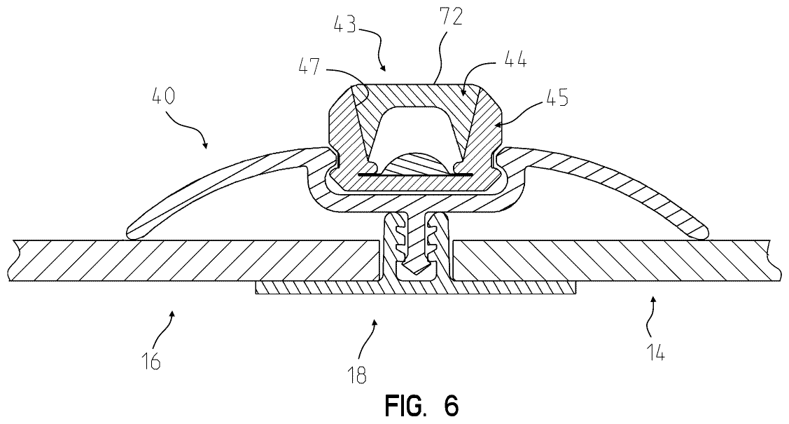

As shown in FIGS. 1 and 2, the lighting system 10 snaps into and is retained by the track receiver 18. The lighting system 10 includes a snap track 40 having a consistent cross-sectional shape along its length, a luminaire strip 42 and optional covers 46. Optional junction box endcaps 48, shown in FIGS. 5 and 6, are sometimes implemented to cover exposed terminal ends of the lighting system 10 and provide a space for concealing electrical connections to the vehicle wiring and/or other lighting systems.

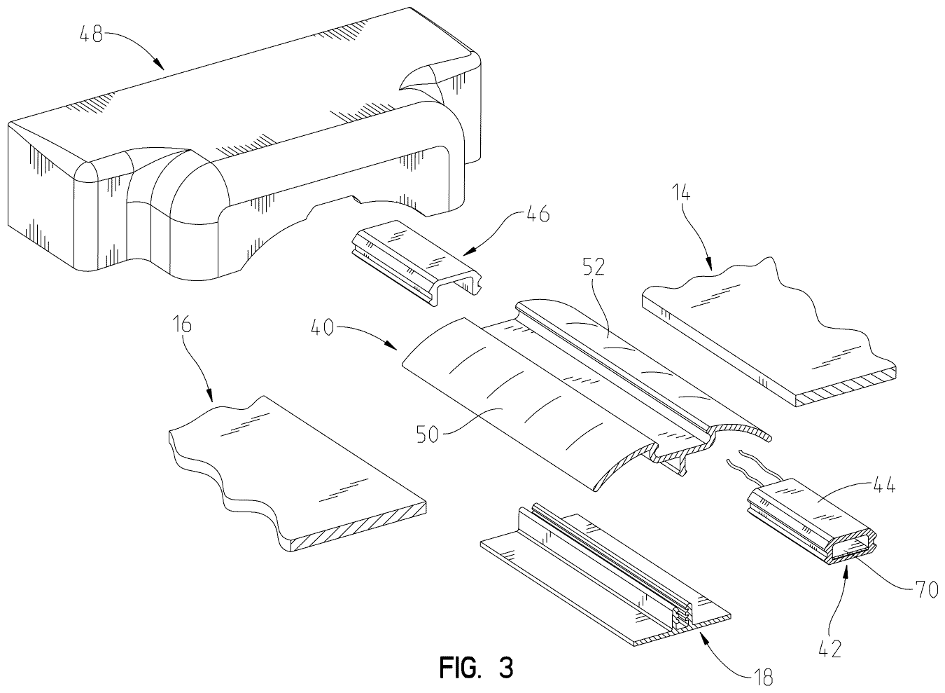

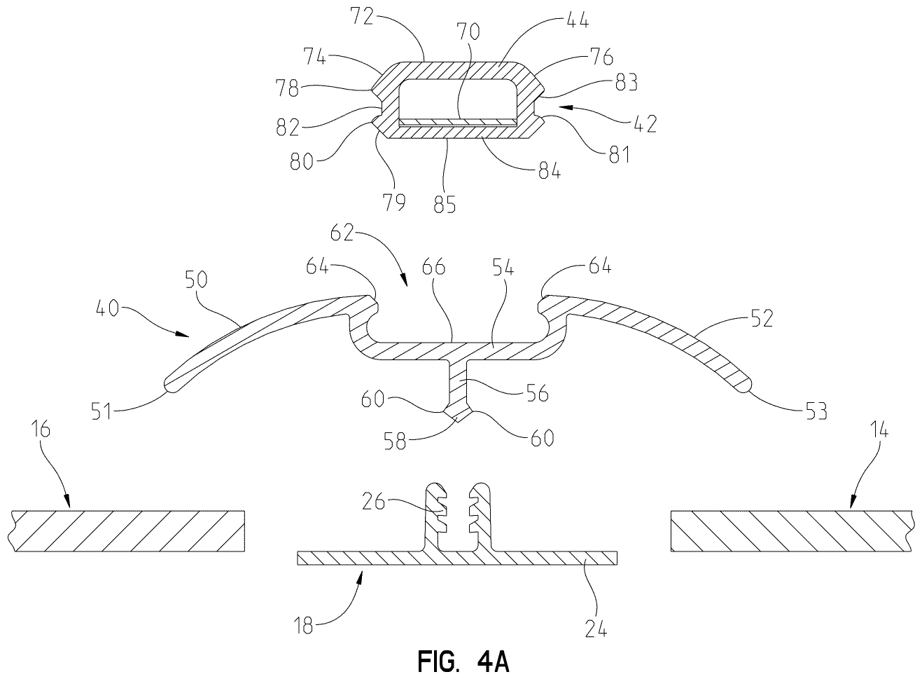

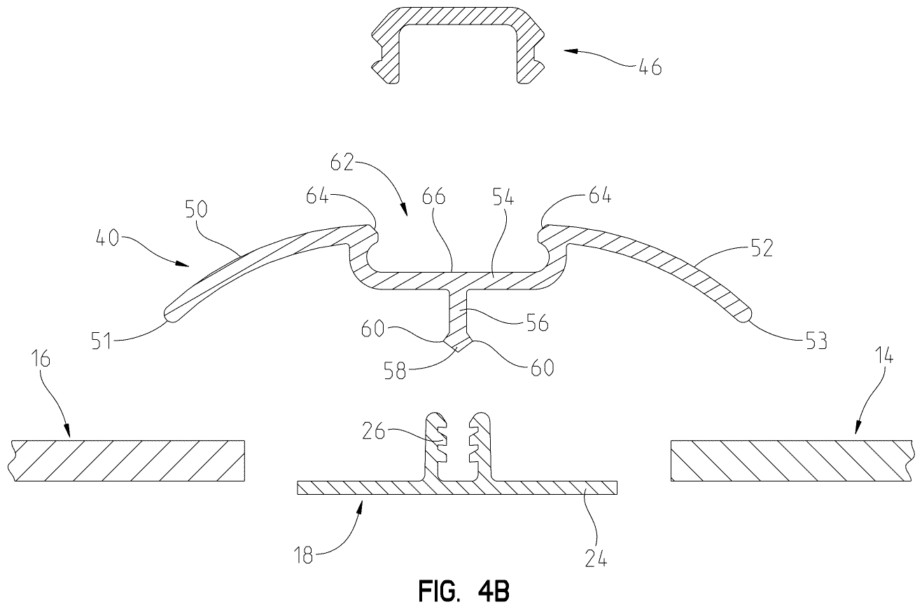

The snap track 40 is mirror symmetrical with a first (left) arcuate portion 50 and a second (right) arcuate portion 52 that are located on opposite sides of a trough portion 54. As shown in exploded view FIG. 3, the arcuate portions 50, 52 have a resting position where no forces are acting on them. When the snap track 40 is installed, the arcuate portions 50, 52 have resilient properties such that terminal ends 51, 53 apply a biasing force to the panels 14, 16 to prevent rattles and maintain contact over any surface irregularities. Extending perpendicularly from the trough portion 54 is a barb portion 56 having a barbed end 58. The barbed end 58 has opposing points 60 for mating with the barb receiving portion 26. A trough 62 is located opposite the barb portion 56 and retains the luminaire strip 42 and/or cover 46. The trough 62 has a mouth 64 formed by the interior-facing terminal edges of the arcuate portions 50, 52. The mouth 64 is more narrow than the trough 62, shown in FIG. 4. A bottom surface 66 extends from one edge of the mouth 64 to the other edge. When the snap track 40 is engaged with the track receiver 18 and the barb portion 56 located in the barb receiving portion 26, the arcuate portions 50, 52 move from the resting position to a deflected position where they are in biased contact with their respective outer surfaces 22, 20.

The luminaire strip 42 has a diffuser portion 44 formed from a resilient transparent or translucent material. The diffuser portion 44 surrounds an elongate series of LED lights 70 that illuminate when electricity is applied. The diffuser portion 44 has an outwardly facing diffuser surface 72 with curved portions 74, 76. The side profile surfaces are mirror symmetrical, each extending from a back surface 85 to their respective curved portion 74, 76. The side profile surfaces each start with an inner chamfer surface 79. The inner chamfer surface 79 begins where it meets the back surface 85 and terminates at an inner widest point 80. When mated to the snap track 40, the distance across the inner widest points 80 is the widest portion of the luminaire strip 42 that is located inside the trough 62. Across the outer widest points 78 is the widest portion of the luminaire strip 42 outside of the trough 62. Between the inner widest point 80 and the outer widest point 78 is a groove that is formed from several surfaces in cooperation. The groove has a convex surface 81 that extends between the inner widest point 80 and groove wall 82 and an outer chamfer surface 83 that extends between the outer widest point 78 and groove wall 82. The convex surface 81 has a convex sectional profile while the outer chamfer surface 83 is straight and angled similarly to the inner chamfer surface 79. The designations of “inner” and “outer” are for identification only and do not specifically refer to orientation or position. To the extent these designations relate to location, the identification relates to where they are located when the luminaire strip 42 is mated to the snap track 40. For example, the outer chamfer surface 83 is partially exposed and inner chamfer surface 79 is located in the trough 62. This can be seen in FIG. 2. The diffuser portion 44 has a backing wall portion 84 that is parallel to the outwardly facing diffuser surface 72 and supports the LED lights 70. The side profile surfaces are complementary to the trough 62 and mouth 64, as shown in FIG. 2. The resilience of the diffuser portion 44 allows installation and removal of the luminaire strip 42. Further, the luminaire strip 42 is retained in the trough 62 of the snap track 40 without adhesive or sealants, relying only on the resilient fit between the mouth 64 and side profile surfaces. As installed, the outwardly facing diffuser surface 72 is proud of the outward facing surfaces of the first and second arcuate portions 50, 52.

It is contemplated that the luminaire strip has a taller cross-sectional shape like the luminaire strip 43 as shown in FIGS. 5 and 6. The luminaire strip 43 mates with the snap track 40 the same as luminaire strip 42, with the same chamfer surface 79, inner widest point 80, convex surface 81, groove wall 82, and outer chamfer surface 83. The diffuser surface 72 and curved portions 74, 76 are the same. The outer widest points 78 are shown as flat portions that are the widest portion of the luminaire strip 43 located outside of the snap track 40. The luminaire strip 43 has a diffuser portion 44 and a director portion 45. The diffuser portion 44 is transparent or translucent, allowing light from the LED lights 70 to pass through. The director portion 45 is made from opaque, tinted, or similar material that at least partially blocks light transmission. In any event, the director portion 45 is less transparent than the diffuser portion 44. In the embodiment shown herein, the director portion 45 and diffuser portion 44 are joined and sealed together. An angled transition 47 defines the transition between the diffuser and director portions and forms a “V” shape to direct light through the diffuser surface 72. The V-shaped transition could be at a wider angle to include the outer widest points 78, such as in the embodiment shown in FIG. 5. The director portion 45 could be wide as shown in FIG. 5 or more narrow as shown in FIG. 6. As installed in the track, the director portion 45 is substantially located in the trough 62 with the diffuser portion 44 being located substantially outside of the mouth 64. For the purposes of this disclosure, the word “substantially” is defined as a majority of the cross-sectional area.

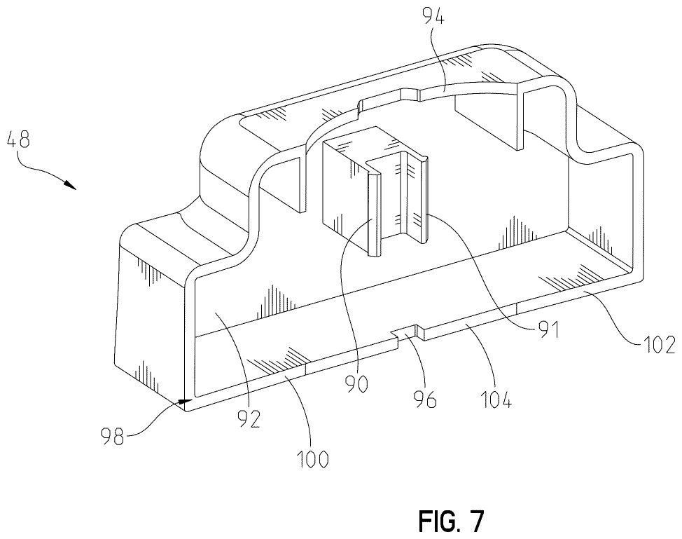

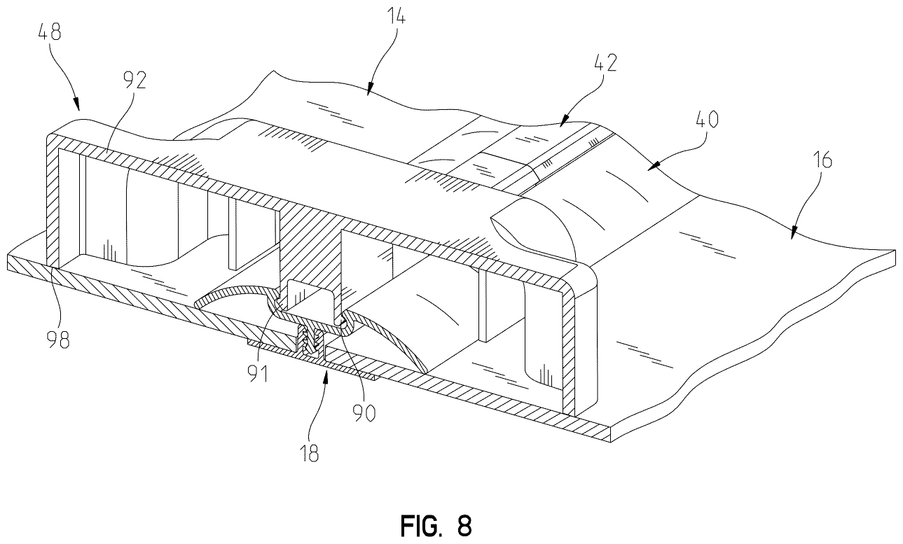

The junction box endcaps 48, shown in FIGS. 7 and 8, snap into the same snap track 40 as the luminaire strip 42 or optional cover 46 using opposing barbed walls 90, 91 that are affixed to an outer wall 92. It is contemplated that the endcap 48 mates directly to the track receiver 18. The opposing barbed walls 90, 91 are sized and spaced to snap and be retained in the trough 62. One side of the endcap 48 has a profile cutout 94 in one of the upstanding walls that matches the profile of the lighting system 10. On the other side, a wiring egress cutout 96 in another upstanding wall allows for power or other wiring to enter the cavity formed by the endcap 48 as installed on the track receiver 18. Both cutouts 94, 96 extend towards the outer wall 92 from a contacting edge 98. As installed, the outer wall 92, the upstanding walls that terminate at the contacting edge 98, the end of the lighting system, and the panels 14, 16 form an enclosed space that conceals connections, wire connectors, or wiring splices.

The panels 14, 16 in the FIGS. are shown as planar structures, but in some applications, the track receiver 18, specifically the additional thickness of the flange portion 24, causes the edges of the panels to deflect where they overlay the flange portion 24. This is shown in FIG. 2 with the panels 14, 16 being displaced adjacent the lighting system 10. This displacement of the panels 14, 16 is accommodated by the contacting edge 98 having a first angled portion 100, a second angled portion 102, and a straight portion 104 located therebetween. The straight portion 104 is parallel to the outer wall 92. This is shown in FIG. 7. The first and second angled portions 100, 102 both extend from where they meet the straight portion 104 to the profile cutout 94. The wiring egress cutout 96 interrupts the straight portion 104.

If the user desires the illumination from the LED lights 70 to stop short of the snap track 40, the luminaire strip 42, 43 is terminated before the terminal end of the snap track 40 and the optional cover 46 is installed, which can conceal any wiring in the trough 62 that feeds the luminaire strip 42, 43. The optional cover 46 matches the profile of the side profile surfaces and outwardly facing surface 72, as can be seen in FIG. 1. The optional cover 46 may be made from opaque, translucent, or transparent material. To conceal any wires from the luminaire strip 42, 43, the cover 46 will be more opaque than the resilient material on the luminaire strip 42, 43.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A lighting system for concealing a gap between a first panel and a second panel, said lighting system comprising:
a track receiver having a flange portion and a barb receiving portion extending perpendicularly therefrom, said barb receiving portion having a pair of upstanding parallel walls, each of said upstanding walls having protrusions cooperating to form a barb-receiving channel;
a snap track having a trough portion, a first resilient arcuate portion extending from a left side of said trough portion, a second resilient arcuate portion extending from a right side of said trough portion, said trough portion having a mouth defining an opening to a valley, said mouth having a width being narrower than a width of said valley, said snap track having a barb extending therefrom in a direction opposite of said mouth, said barb retainable by said barb-receiving channel;
an elongate luminaire strip having a first side profile surface, an oppositely located second side profile surface, a diffuser surface extending between said profile surfaces, and a back surface located opposite said diffuser surface, each said side profile surface having a chamfer surface extending outwardly at an oblique angle from said back surface to an inner widest point, a groove extending from said inner widest point and an outer widest point, said groove having a convex surface extending from said inner widest point to a groove wall, said groove wall extending to an outer chamfer surface, said outer chamfer surface extending to said outer widest point, said back surface extending between said chamfer surfaces of said first and second side profile surface;
said elongate luminaire strip is releasably retained in said trough portion without adhesive when said grooves are located in said mouth and said inner widest points of said profile surfaces are located in said valley, said diffuser surface is proud of said first and second resilient arcuate portions; and
when said snap track is retained by said track receiver and said track receiver is affixed in said gap between said first and second panels, said first resilient arcuate portion is in biased contact with said first panel and said second resilient arcuate portion is in biased contact with said second panel.

2. The lighting system of claim 1, wherein said second side profile surface is mirror symmetrical to said first side profile surface.

3. The lighting system of claim 1, further comprising an endcap for being selectively retained by said track receiver or said snap track, said endcap having an outer wall and upstanding walls extending therefrom, one of said upstanding walls having a profile cutout matching a profile of said luminaire strip as installed in said snap track, said upstanding walls of said endcap having a contacting edge, said contacting edge having a straight portion being parallel to said outer wall, said contacting edge having first and second angled portions flanking said straight portion.

4. The lighting system of claim 1, wherein said elongate luminaire strip is formed from a resilient material having a translucent portion joined to a director portion at a V-shaped angled transition, said director portion being more opaque than said translucent portion, when said elongate luminaire strip is retained in said snap track, said director portion is substantially located in said trough portion.

5. The lighting system of claim 1, further comprising a cover mateable to said snap track, said cover having a first and second side profile surface connected by a diffuser surface, said first and second side profile surfaces on said cover matching said profile surfaces on said luminaire, said cover formed from a material having a greater opacity than said elongate luminaire strip.

6. A lighting system for connecting to an existing track receiver affixed between two panels, said track receiver having a barb receiving portion formed from a pair of upstanding parallel walls, said barb receiving portion protruding through a gap between said two panels, said lighting system comprising:
a snap track having a trough portion and a barb extending therefrom for engaging with said track receiver, said snap track having a first arcuate portion connected to a left side of said trough portion and a second arcuate portion connected to a right side of said trough portion, said first and second arcuate portions resiliently deformable between a resting position and a deflected position, a portion of said first and second arcuate portions extending over said trough portion to form a mouth, said mouth being more narrow than said trough portion;
a luminaire strip having a resilient exterior enclosing an elongate LED strip, said resilient exterior having side profile surfaces complementary to said trough portion; and
when said luminaire strip is located in said trough portion, a diffuser surface on said resilient exterior is proud of said arcuate portions.

7. The lighting system of claim 6, further comprising a cover, said cover having an outwardly facing surface and side profile surfaces matching said side profile surfaces and said diffuser surface on said luminaire strip.

8. The lighting system of claim 6, wherein said side profile surfaces each having a groove, said mouth engaged with said grooves to retain said luminaire strip in said snap track.

9. The lighting system of claim 6, wherein said side profile surfaces on said luminaire strip are mirror symmetrical, said diffuser surface extending between said side profile surfaces and a back surface located opposite said diffuser surface, each said side profile surface having a chamfer surface extending outwardly at an oblique angle from said back surface to an inner widest point, a groove extending from said inner widest point and an outer widest point, said groove having a convex surface extending from said inner widest point to a groove wall, said groove wall extending to an outer chamfer surface, said outer chamfer surface extending to said outer widest point, said back surface extending between said chamfer surfaces of said first and second side profile surface.

10. The lighting system of claim 9, further comprising a cover having a first and second side profile surface connected by an outwardly facing surface, said first and second profile surfaces on said cover matching said profile surfaces on said luminaire, said outwardly facing surface on said cover matching said diffuser surface on said luminaire strip, said cover formed from a material having a greater opacity than said elongate luminaire strip.

11. The lighting system of claim 6, wherein said resilient exterior has a diffuser portion joined to a director portion at a V-shaped angled transition, said diffuser portion being less opaque than said director portion, said diffuser surface is located on said diffuser portion.

12. The lighting system of claim 6, further comprising an endcap for being selectively retained in said track receiver or said snap track, said endcap having an outer wall and upstanding walls extending therefrom, one of said upstanding walls having a profile cutout matching an outer profile of said luminaire strip as installed in said snap track.

13. The lighting system of claim 12, wherein said upstanding walls of said endcap having a contacting edge, said contacting edge having a straight portion being parallel to said outer wall, said contacting edge having first and second angled portions flanking said straight portion.

14. A lighting system in combination with a first panel and a second panel, said first panel fixed with respect to and spaced from said second panel to form a gap therebetween, said lighting system comprising:
a track receiver having a flange portion and a barb receiving portion extending perpendicularly therefrom, said barb receiving portion extending through said gap and having a pair of upstanding parallel walls with protrusions on one of said upstanding walls facing protrusions on a second of said upstanding walls;
a snap track having a trough portion, a first resilient arcuate portion extending from one side of said trough portion, a second resilient arcuate portion extending from an opposite side of said trough portion, said trough portion having a mouth defining an opening to a valley, said mouth having a width being narrower than a width of said valley;
an elongate luminaire strip having a first side profile surface, a second side profile surface, a diffuser surface extending between said profile surfaces, and a back surface located opposite said diffuser surface, each said side profile surface having a groove;
said elongate luminaire strip is releasably retained in said trough portion without adhesive when said grooves are located in said mouth, said diffuser surface is proud of said first and second resilient arcuate portions;
when said snap track is retained by said track receiver, said first resilient arcuate portion is in biased contact with said first panel and said second resilient arcuate portion is in biased contact with said second panel.

15. The lighting system of claim 14, further comprising a cover having a first and second side profile surface connected by a diffuser surface, said first and second side profile surfaces on said cover matching said profile surfaces on said luminaire, said cover formed from a material having a greater opacity than said elongate luminaire strip.

16. The lighting system of claim 14, when said luminaire strip is retained in said snap track, said snap track is in biased contact with said luminaire strip.

17. The lighting system of claim 14, further comprising an endcap for being selectively retained in said track receiver or said snap track, said endcap having an outer wall and upstanding walls extending therefrom, one of said upstanding walls having a profile cutout matching a profile of said luminaire strip as installed in said snap track, said upstanding walls of said endcap having a contacting edge, said contacting edge having a straight portion being parallel to said outer wall, said contacting edge having first and second angled portions flanking said straight portion.

18. The lighting system of claim 14, wherein said elongate luminaire strip is formed from a resilient material having a translucent portion joined to a director portion, said diffuser portion being less opaque than said director portion, said diffuser surface is located on said diffuser portion.

19. The lighting system of claim 14, wherein said profile surfaces on said luminaire strip are mirror symmetrical, said diffuser surface extending between said profile surfaces and a back surface located opposite said diffuser surface, each said side profile surface having a chamfer surface extending outwardly at an oblique angle from said back surface to an inner widest point, said groove extending from said inner widest point and an outer widest point, said groove having a convex surface extending from said inner widest point to a groove wall, said groove wall extending to an outer chamfer surface, said outer chamfer surface extending to said outer widest point, said back surface extending between said chamfer surfaces of said first and second side profile surface.

20. The lighting system of claim 19, wherein said elongate luminaire strip has a translucent portion and a director portion, said director portion being more opaque than said translucent portion, said groove wall, said inner widest point, and said back surface are located on said director portion.
